(19) United States
(12) Patent Application Publication
(10) Pub. No.: US 2017/0089471 A1
(43) Pub. Date: Mar. 30, 2017

(54) VENTILATION SYSTEMS AND GASPER VALVES WITH FLEXIBLE COMPONENTS

(71) Applicant: Gulfstream Aerospace Corporation, Savannah, GA (US)

(72) Inventor: Mike Lucas, Savannah, GA (US)

(21) Appl. No.: 14/867,721

(22) Filed: Sep. 28, 2015

(51) Int. Cl. F16K 1/42; B64D 13/00

(52) U.S. Cl. CPC F16K 1/42; B64D 13/00; B64D 2013/003

(57) ABSTRACT

Ventilation systems and gasper valves for ventilating passenger compartments of aircraft are disclosed herein. The ventilation system includes, but is not limited to, an air supply conduit and a gasper valve. The gasper valve includes a poppet and an annular nozzle. The poppet is configured to move between a closed position and an open position and defines a sealing surface. The annular nozzle has a nozzle throat opposing the sealing surface of the poppet. At least one of the sealing surface and the nozzle throat comprises a flexible material configured to at least partially deform in the closed position to restrict air leakage between the poppet and the annular nozzle.

### TECHNICAL FIELD

The present invention generally relates to gasper valves in ventilation systems of aircraft, and more particularly relates to gasper valves with flexible components.

### BACKGROUND

A modern passenger aircraft commonly includes a ventilation system that is configured to direct a stream of cooled (or heated) air towards each passenger onboard the aircraft. Typically, each passenger is presented with an adjustable nozzle that is mounted in an overhead compartment and which the passenger can manipulate and reposition to control the direction of the stream of air. For example, the nozzle may be configured as a sphere and may be mounted in a ball socket in the overhead compartment. By moving the spherical nozzle in the ball socket, the passenger can control the direction of the stream of air.

The nozzle also includes an integrated valve that the passenger may open and/or close at will. Commonly, the valve is a poppet valve that includes a poppet and an opening that is configured to engage with, and to be obstructed by, the poppet. As the passenger unscrews and/or screws an actuator on the nozzle, the poppet is retracted and/or extended causing the poppet valve to open and/or close, respectively. When the poppet valve is opened, the stream of air flows out of the nozzle and when the poppet valve is closed, the stream of air is cut off. Accordingly, the conventional ventilation system described above allows each passenger to turn the stream of air on and off at will and to direct the stream of air towards a desired target. This level of control provides for the comfort of the passengers. This style of adjustable ventilation is commonly referred to as a ‘gasper’ in aviation applications.

As passenger cabins in aircraft become quieter, the noise generated by such gasper valves has become a significant source of disturbance to the passengers. One type of noise generated by conventional gasper valves is air leakage when the gasper valve is closed. The upstream pressure creates a pressure differential across the nozzle sealing mechanism that will leak if it does not seal well. Conventional gaspers have hard plastic or metal internal parts that cannot form a perfect seal when they bear against each other because of geometrical imperfections. These imperfect seals result in small leaks that create high frequency hissing noise when the gasper valve is closed. The high frequency hiss is an annoyance to the aircraft passengers.

One approach to reducing leakage is to add an o-ring to the gasper valve. Although such o-rings are effective at reducing leakage through the gasper in the closed position, the o-ring disrupts the smooth flow of air through the gasper when the gasper is in the open position. Such disruption of the smooth flow of air results in increased noise disturbance to the passenger.

While the above described ventilation system is adequate, there is room for improvement. Accordingly, it is desirable to provide a ventilation system that reduces the air leakage when the gasper valve is in the closed position. In addition, it is desirable to provide a ventilation system that has smooth air flow characteristics when the gasper is in the open position. Furthermore, other desirable features and characteristics will become apparent from the subsequent detailed description and the appended claims, taken in conjunction with the accompanying drawings and the foregoing technical field and background.

### BRIEF SUMMARY

Ventilation systems and gasper valves for ventilating aircraft passenger compartments are disclosed herein.

In a first non-limiting embodiment, a gasper valve includes, but is not limited to, a poppet and an annular nozzle. The poppet is configured to move between a closed position and an open position and defines a sealing surface. The annular nozzle has a nozzle throat opposing the sealing surface of the poppet. At least one of the sealing surface and the nozzle throat comprises a flexible material configured to at least partially deform in the closed position to restrict air leakage between the poppet and the annular nozzle.

In a second non-limiting embodiment, a ventilation system includes, but is not limited to, an air supply conduit and a gasper valve. The air supply conduit is configured to direct air from an environmental control system to the passenger compartment. The gasper valve fluidly couples the air supply conduit to the passenger compartment and includes a poppet and an annular nozzle. The poppet is configured to move between a closed position and an open position and defines a sealing surface. The annular nozzle has a nozzle throat opposing the sealing surface of the poppet. The sealing surface and/or the nozzle throat comprise a flexible material configured to at least partially deform in the closed position to restrict air leakage between the poppet and the annular nozzle.

### BRIEF DESCRIPTION OF THE DRAWINGS

The present invention will hereinafter be described in conjunction with the following drawing figures, wherein like numerals denote like elements, and

FIG. 1 is an environmental view illustrating an interior of a cabin compartment of an aircraft that includes a non-limiting embodiment of a ventilation system with a gasper valve made in accordance with the teachings of the present disclosure; and

FIGS. 2, 3, and 4 are cross-sectional views illustrating interior portions of non-limiting embodiments of ventilation systems made in accordance with the teachings of the present disclosure.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

An improved ventilation system with an improved gasper valve is disclosed herein. As compared with conventional ventilation systems, the gasper valve of the present disclosure includes components made from flexible material. The flexible material deforms when the gasper valve is closed to form a seal that significantly reduces leakage in the closed position when compared with conventional gasper valves having only hard plastic or metal components that do not deform upon sealing. The improved gasper valve further offers reduced noise in the open position when compared with conventional gasper valves that utilize o-rings for sealing in the closed position.

A greater understanding of the ventilation system and gasper valve described above may be obtained through a review of the illustrations accompanying this application together with a review of the detailed description that follows.

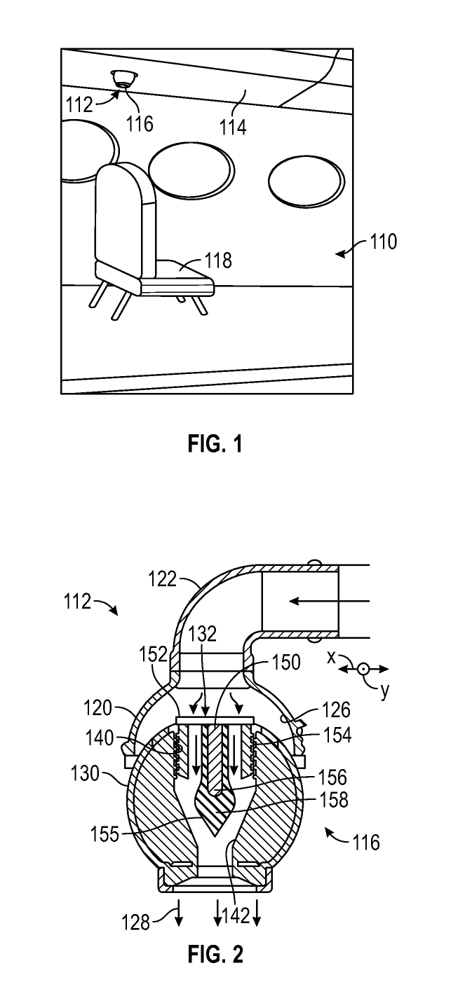

FIG. 1 is an environmental view illustrating an interior portion of a cabin compartment 110 of a privately owned business jet. Although the context of the discussion contained herein is with respect to a privately owned business jet, it should be understood that the teachings of the present disclosure are compatible with all types of aircraft including, but not limited to, private propeller driven aircraft, private jets, commercial jet passenger aircraft, commercial propeller driven passenger aircraft, cargo aircraft, military aircraft, and the like. Furthermore, although the ventilation system disclosed herein is described as being compatible for use on board an aircraft, it should be understood that the present ventilation system is compatible with all types of vehicles. For example, and without limitation, the ventilation system disclosed herein may be implemented on board automobiles, buses, trains, ships, spacecraft, and any other type of conveyance. Additionally, the ventilation system disclosed herein is not limited to implementation on vehicles, but may also be compatible for use in tents, houses, buildings, stadiums, theaters, and other permanent and/or semi-permanent structures.

Cabin compartment 110 includes an embodiment of a ventilation system 112 made in accordance with the teachings of the present disclosure. In the illustrated embodiment, ventilation system 112 is housed in an overhead compartment 114 which is configured to house ventilation system 112 as well as other equipment needed to support ventilation system 112 and to support operation of the aircraft. Ventilation system 112 includes a gasper valve 116. Gasper valve 116 has a ball-in-socket type of arrangement that permits a passenger to manipulate gasper valve 116 and, in turn, to direct the stream of air emitted by ventilation system 112 towards a desired area.

A passenger seat 118 is positioned below ventilation system 112 and is configured to receive a passenger of the aircraft. In the illustrated embodiment, a single ventilation system 112 is devoted to cooling and/or heating the passenger of a single passenger seat 118. In other embodiments, multiple ventilation systems 112 may be configured to direct streams of air towards a single passenger seat 118. In still other embodiments, a single ventilation system 112 may be configured to provide multiple streams of air to multiple passenger seats 118.

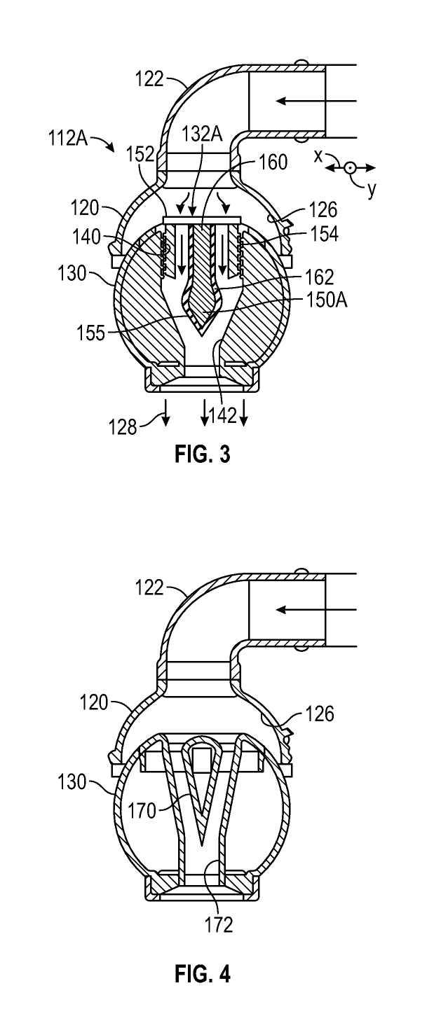

FIG. 2. is a cross-sectional view illustrating ventilation system 112. Ventilation system 112 includes gasper valve 116, gasper mount 120, and air supply conduit 122. Gasper mount 120 receives gasper valve 116 for rotation within a cavity 126 defined by gasper mount 120. Gasper mount 120 is mounted to overhead compartment 114 to restrict translation of gasper valve 116 while permitting user rotation of gasper valve 116 within cavity 126 to direct an air flow 128 that exits gasper valve 116.

Air supply conduit 122 extends out of a rear portion of gasper mount 120. Air supply conduit 122 may comprise any type of conventional hosing that is effective to contain and direct a flow of air. For example, air supply conduit 122 may be constructed of any suitable material including, but not limited to, metals, rubbers, plastics, and polymeric materials. Air supply conduit 122 directs conditioned air to gasper mount 120 from environmental control systems of the aircraft.

In the illustrated embodiment, gasper valve 116 is a poppet valve. As illustrated, gasper valve 116 has a generally spherical configuration which allows gasper valve 116 to be swiveled about both an X axis and a Y axis within cavity 126 with respect to gasper mount 120. This provides a passenger in cabin compartment 110 with flexibility in directing air flow 128 emitted by gasper valve 116. Gasper valve 116 includes a nozzle 130 and a valve member 132. Nozzle 130 and valve member 132 define a pathway to guide and accelerate the flow of air passing through ventilation system 112 to form the relatively high-speed stream of air emitted by gasper valve 116.

Nozzle 130 is an annular member that includes a threaded portion 140 and a throat portion 142. Threaded portion 140 cooperates with a threaded portion of valve member 132 to move valve member 132 between an open position and a closed position, as will be described below. Throat portion 142 opposes valve member 132 and defines a reducing cross-sectional area along the direction of air flow 128.

In some embodiments where valve member 132 is a flexible material, throat portion 142 is a stiff material. In some embodiments where valve member 132 is a stiff material, throat portion 142 is a flexible material. In some embodiments, both valve member 132 and throat portion 142 comprise flexible materials. As used herein, the term “flexible material” refers to a material that substantially maintains shape under the forces caused by air flow 128, but readily elastically deforms under forces resulting from closure of gasper valve 116. For example, the flexible material may be an elastomeric or rubber material. In contrast, stiff materials such as metals and hard plastic materials—although capable of some degree of elastic deformation under greater forces—are explicitly excluded from the preceding definition of “flexible material.” As will be appreciated by those with ordinary skill in the art, the specific flexible material may vary based on the forces involved in any particular implementation of ventilation system 112.

Valve member 132 is positioned at an upstream portion of gasper valve 116 and is configured to move between an open position and a closed position. Valve member 132 includes a poppet 150, tab members 152, and threaded portion 154. Valve member 132 further defines a sealing surface 155 that opposes throat portion 142 of nozzle 130. When valve member 132 is in the open position, a gap between sealing surface 155 and throat portion 142 permits air flow 128 to be expelled from ventilation system 112. When valve member 132 is in the closed position, sealing surface 155 deforms against throat portion 142 to seal gasper valve 132 and restrict air flow out of ventilation system 112.

Poppet 150 is substantially symmetrical and is contoured to have a generally aerodynamic shape. Poppet 150 includes a post 156 and a sheathe 158. In the example provided, post 156 is substantially cylindrical and is a substantially rigid plastic material. Sheathe 158 at least partially encompasses post 156 and comprises the flexible material that defines sealing surface 155. In the example provided, the flexible material is an elastomeric material that defines a substantially conical sealing surface 155. In some embodiments, the entire poppet 150 may be formed from the flexible material. In some other embodiments, only an end portion of the poppet 150 may be formed from the flexible material. It should be appreciated that different portions of the poppet may be formed from the flexible material without departing from the scope of the present disclosure.

Tab members 152 project radially from poppet 150 to threaded portion 154 to hold poppet 150 in place in a lateral center of nozzle 130, as will be appreciated by those with ordinary skill in the art.

During opening and closing of gasper valve 116, a passenger rotates nozzle 130 to cause threaded portion 140 to rotate. Threaded portion 140 acts against threaded portion 154, which is held rotationally stationary within nozzle 130. Because threaded portion 154 is held rotationally stationary, forces from threaded portion 140 cause threaded portion 154 to translate upstream or downstream, depending on the direction of rotation and the thread type. Threaded portion 154 transfers the translation forces to poppet 150 through tab members 152.

Translating poppet 150 downstream puts valve member 132 in a closed position in which sealing surface deforms against throat portion 142 to seal against leakage from the high pressure air in air supply conduit 122. Translating poppet 150 upstream puts valve member 132 into an open position in which there is a gap between sealing surface 155 and throat portion 142. Poppet 150 and nozzle 130 are configured to minimize disruption of a free flow of air through valve member 132 in the open position. For example, the aerodynamic shape of poppet 150 reduces noise when compared with conventional gasper valves that include o-rings, which disrupt the flow of air exiting the gasper valve.

FIG. 3. is a cross-sectional view illustrating a ventilation system 112A. Ventilation system 112A is similar to ventilation system 112, where like numbers refer to like components. Ventilation system 112A, however, includes valve member 132A. Valve member 132A includes poppet 150A. Poppet 150A includes a main body 160 and a coating 162. In the example provided, main body 160 is a rigid plastic material and coating 162 is a flexible elastomeric material with a thickness between about three hundredths of an inch to one tenth of an inch. It should be appreciated that the thickness of coating 162 may vary without departing from the scope of the present disclosure. Coating 162 substantially conforms to the shape of main body 160 and defines sealing surface 155. Coating 162 deforms against throat portion 142 in the closed position to seal against air leakage. In the example provided, coating 162 extends across the entire poppet 150A. In some embodiments, coating 162 extends across only an end portion of poppet 150A. It should be appreciated coating 162 may be disposed on other portions of poppet 150A without departing from the scope of the present disclosure.

FIG. 4 is a cross-sectional view illustrating a ventilation system 112B. Ventilation system 112B is similar to ventilation system 112, where like numbers refer to like components. Ventilation system 112B, however, includes a teardrop shaped poppet 170 and elongated nozzle throat 172. In the example provided, poppet 170 comprises a flexible elastomeric material and nozzle throat 172 comprises a rigid plastic material. It should be appreciated that other shapes for components of ventilation systems 112, 112A, or 112B may be incorporated without departing from the scope of the present disclosure.

While at least one exemplary embodiment has been presented in the foregoing detailed description of the disclosure, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the disclosure as set forth in the appended claims.

What is claimed is:

1. A gasper valve for ventilating a passenger compartment of an aircraft, the gasper valve comprising:
a poppet configured to move between a closed position and an open position, the poppet having a sealing surface; and
an annular nozzle having a nozzle throat opposing the sealing surface of the poppet, and
wherein at least one of the sealing surface and the nozzle throat comprises a flexible material configured to at least partially deform in the closed position to restrict air leakage between the poppet and the annular nozzle.

2. The gasper valve of claim 1, wherein the sealing surface comprises the flexible material.

3. The gasper valve of claim 2, wherein the poppet includes a post and a sheath at least partially encompassing the post, and wherein the sheath comprises the flexible material and defines the sealing surface.

4. The gasper valve of claim 3, wherein the sheath comprises an elastomeric material.

5. The gasper valve of claim 3, wherein the post is substantially cylindrical and the sealing surface is substantially conical.

6. The gasper valve of claim 2, wherein the poppet includes a main body and a coating covering the main body, and wherein the coating comprises the flexible material and defines the sealing surface.

7. The gasper valve of claim 6, wherein the coating comprises an elastomeric material.

8. The gasper valve of claim 6, wherein the coating has a thickness of about three hundredths of an inch to about one tenth of an inch.

9. The gasper valve of claim 1, wherein the nozzle throat comprises the flexible material.

10. The gasper valve of claim 1, wherein the poppet is further configured to fully seal against the nozzle throat under a compressive force resulting from a closing of the gasper valve.

11. The gasper valve of claim 1, wherein the poppet and the sealing surface are configured to minimize disruption of a free flow of air through the gasper valve in the open position.

12. A ventilation system for a passenger compartment of an aircraft, the ventilation system comprising:
an air supply conduit configured to direct air from an environmental control system to the passenger compartment; and
a gasper valve fluidly coupling the air supply conduit to the passenger compartment, the gasper valve including:
a poppet configured to move between a closed position and an open position, the poppet having a sealing surface; and
an annular nozzle having a nozzle throat opposing the sealing surface of the poppet, and
wherein at least one of the sealing surface and the nozzle throat comprises a flexible material configured to at least partially deform in the closed position to restrict air leakage between the poppet and the annular nozzle.

13. The ventilation system of claim 12, wherein the sealing surface comprises the flexible material.

14. The ventilation system of claim 13, wherein the poppet includes a post and a sheath at least partially encompassing the post, and wherein the sheath comprises the flexible material and defines the sealing surface.

15. The ventilation system of claim 14, wherein the sheath comprises an elastomeric material.

16. The ventilation system of claim 14, wherein the post is substantially cylindrical and the sealing surface is substantially conical.

17. The ventilation system of claim 13, wherein the poppet includes a main body and a coating covering the main body, and wherein the coating comprises the flexible material and defines the sealing surface.

18. The ventilation system of claim 17, wherein the coating has a thickness of about three hundredths of an inch to about one tenth of an inch.

19. The ventilation system of claim 12, wherein the poppet is further configured to fully seal against the nozzle throat under a compressive force resulting from a closing of the gasper valve.

20. The ventilation system of claim 12, wherein the poppet and the sealing surface are configured to minimize disruption of a free flow of air through the gasper valve in the open position.
